(19) United States
(12) Patent Application Publication
(10) Pub. No.: US 2024/0384141 A1
(43) Pub. Date: Nov. 21, 2024

(54) SHOCK-RESISTANT ADHESIVE COMPOUND

(71) Applicant: TESA SE, Norderstedt (DE)

(72) Inventors: Anika PETERSEN, Heidmühlen (DE); Ann-Kathrin NÄGELE, Hamburg (DE)

(73) Assignee: TESA SE, Norderstedt (DE)

(21) Appl. No.: 18/574,558

(22) PCT Filed: Jun. 27, 2022
(86) PCT No.: PCT/EP2022/067566

§ 371 Date: Dec. 27, 2023

(30) Foreign Application Priority Data
Jun. 28, 2021 (DE) 10 2021 206 697.6

(51) Int. Cl. C09J 133/10; C09J 5/00; C09J 7/38

(52) U.S. Cl. CPC C09J 133/10; C09J 5/00; C09J 7/385; C09J 2203/326; C09J 2301/20; C09J 2301/302; C09J 2409/00; C09J 2423/00; C09J 2433/00

(57) ABSTRACT

Shock-resistant adhesive compounds and methods are provided and comprise a) at least about 50% by weight, based on a total weight of the pressure sensitive adhesive, of at least one poly(meth)acrylate, b) about 15-35% by weight, based on the total weight of the pressure sensitive adhesive, of a synthetic rubber component comprising at least one vinylaromatic-butadiene block copolymer and at least one vinylaromatic-isoprene block copolymer, and c) at least one tackifying resin compatible with the synthetic rubber component, wherein a weight ratio of vinylaromatic-butadiene block copolymer(s): vinylaromatic-isoprene block copolymer(s) is about 1.1:1 to about 2.5:1. The methods bond one or more components of at least one portable device with the shock-resistant adhesive compounds.

The invention relates to the technical field of pressure sensitive adhesives, as used as such or as a constituent of adhesive tapes in a wide variety of different fields of industry. In particular, the invention proposes a shock-resistant pressure sensitive adhesive having good cohesion based on poly(meth)acrylate and a specific synthetic rubber component. The pressure sensitive adhesive of the invention may especially be used in the manufacture of electronic devices.

In many fields of technology, adhesive tapes are increasingly being used for bonding of components. It is ever more commonly the case that the adhesive tapes have to meet very different demands that are frequently even contradictory. It is almost always the case, for example, that good adhesion is desired, but often also in conjunction with good cohesion. Adhesion is based essentially on the ability of the pressure sensitive adhesive in the adhesive tape to adapt to the adherend. However, improved cohesion generally requires an increase in viscosity of the pressure sensitive adhesive, and hence reduces its adaptation capacity. It can be surmised from this schematic example that, in the formulation of pressure sensitive adhesives, the influences of the various components have to be balanced very carefully in order to achieve a satisfactory overall outcome.

In this context, pressure sensitive adhesives have for some time been formulated on the basis of a mixture or blend of poly(meth)acrylate with one or more synthetic rubbers. In this way, it is possible, for example, to achieve pressure sensitive adhesives that achieve good bonding forces not just—in accordance with the nature of the polyacrylate component—on adherends having comparatively high surface energy, but also on those having moderate or low surface energy, for example particular plastic surfaces or else varnishes.

There are numerous examples in the prior art as to how particular profiles of properties of pressure sensitive adhesives are achieved by specific selection of poly(meth)acrylate and synthetic rubber components.

U.S. Pat. No. 4,107,233 A describes an improvement in adhesion to and printability of styrene-butadiene copolymers (SBC) by addition of polyacrylate.

EP 0 349 216 A1 discloses an improvement in the low-temperature impact resistance of polyacrylate pressure sensitive adhesives by the addition of SBC, where 95 to 65 parts polyacrylate are blended with 5 to 35 parts SBC.

EP 0 352 901 A1 relates to pressure sensitive adhesives containing 60 to 95 parts of a UV-polymerized polyacrylate and 35 to 5 parts of a synthetic rubber. This formulation improves low-temperature impact resistance and bonding to paints.

EP 0 437 068 A2 discloses cellular pressure sensitive adhesive membranes based on polyacrylate/SBC blends with improved low-temperature impact resistance.

WO 95/19393 A1 describes a blend of a styrene block copolymer modified with a carboxyl group and a polyacrylate containing at least one nitrogen-containing monomer type. One aim of this methodology is improvement of bonding properties on low-energy substrates.

WO 2008/070386 A1 describes polymer blends containing at least 92 parts of an SBC-based adhesive and up to 10 parts of a polyacrylate component.

WO 2000/006637 A1 discloses blends of polyacrylates and SBC as a basis for foamed adhesive layers.

EP 2 832 811 A1 presents a pressure sensitive adhesive intended to achieve good bond strengths at both high and low temperatures. The pressure sensitive adhesive contains the following components:
40-70% by weight of at least one poly(meth)acrylate,
15-50% by weight of at least one synthetic rubber, and
at least one tackifier compatible with the poly(meth)acrylate.

In the production of electronic devices as well, in view of the sustained trend toward miniaturization of the devices, there is increasing use of adhesive tapes and pressure sensitive adhesives. In this way, it is possible to achieve bonds between the components in a significantly more positionally accurate and space-saving manner. Since, however, because of the ever-increasing global demand for communication and entertainment electronics, demands on the performance of the devices are also rising constantly, and the pressure sensitive adhesives used are also constantly subject to new, but at least increasing demands.

It was an object of the invention to provide a pressure sensitive adhesive having good shock resistance and high internal strength, the latter especially with respect to stresses in z direction. Of course, the pressure sensitive adhesive was also to have good adhesive properties.

It was a further object of the invention to configure the pressure sensitive adhesive to be specified in such a way that, as well as the properties already mentioned, it also has good chemical resistance, especially toward amphiphilic substances.

The achievement of the object is based on the idea of using a poly(meth)acrylate-based pressure sensitive adhesive blended with a specifically formulated synthetic rubber component.

A first and general subject of the invention is a pressure sensitive adhesive comprising
a) at least 50% by weight, based on the total weight of the pressure sensitive adhesive, of at least one poly(meth)acrylate;
b) 15-35% by weight, based on the total weight of the pressure sensitive adhesive, of a synthetic rubber component comprising at least one vinylaromatic-butadiene block copolymer and at least one vinylaromatic-isoprene block copolymer; and
c) at least one tackifying resin compatible with the synthetic rubber component
and characterized in that the weight ratio of vinylaromatic-butadiene block copolymer(s): vinylaromatic-isoprene block copolymer(s) is 1.1:1 to 2.5:1.

Such a pressure sensitive adhesive was able to achieve the profile of properties required.

In line with general understanding, a pressure sensitive adhesive is understood to mean a material having the property of entering into a permanent bond with a substrate even under relatively gentle contact pressure. Pressure sensitive adhesives generally have permanent intrinsic tack at room temperature, meaning that they have a certain viscosity and touch-tackiness. This is attributed in particular to the fact that they wet the surface of a substrate even under gentle contact pressure.

Without wishing to be tied to this theory, it is frequently assumed that a pressure sensitive adhesive can be regarded as a liquid of extremely high viscosity with an elastic component, which accordingly has characteristic viscoelastic properties that lead to the above-described permanent intrinsic tack and pressure sensitive adhesiveness. It is assumed that, in the case of pressure sensitive adhesives, under mechanical deformation, there are both viscous flow processes and buildup of elastic resilience forces. The proportion of viscous flow serves to achieve adhesion, while the proportion of elastic resilience forces is needed especially to achieve cohesion. The correlations between rheology and touch-tackiness are known in the prior art and are described, for example, in “Satas, Handbook of Pressure Sensitive Adhesives Technology”, Third Edition, (1999), pages 153 to 203.

The size of the elastic and viscous components is typically characterized using the storage modulus (G′) and loss modulus (G″), which can be ascertained by dynamic-mechanical analysis (DMA), for example using a rheometer, as disclosed, for example, in WO 2015/189323 A1.

In the context of the present invention, an adhesive is preferably regarded as pressure-sensitive and hence as a pressure sensitive adhesive when, at a temperature of 23° C., in the deformation frequency range from 10⁰ to 10¹ rad/sec, G′ and G″ are each at least partly in the range from 10³ to 10⁷ Pa.

Poly(meth)acrylates are fundamentally known to the person skilled in the art. In the context of the present invention, the expression “poly(meth)acrylates”, in accordance with the understanding of the person skilled in the art, encompasses both polyacrylates and polymethacrylates.

According to the invention, the pressure sensitive adhesive comprises at least 50% by weight of at least one poly(meth)acrylate. In principle, the pressure sensitive adhesive may comprise either (exactly) one poly(meth)acrylate or two or more poly(meth)acrylates.

Where the plural “poly(meth)acrylates” is used hereinafter, this explicitly also encompasses embodiments with (exactly) one poly(meth)acrylate.

The pressure sensitive adhesive of the invention preferably comprises poly(meth)acrylates to an extent of not more than 70% by weight, especially 52% to 65% by weight, most preferably to an extent of 54% to 60% by weight.

The glass transition temperature of the poly(meth)acrylate in the pressure sensitive adhesive of the invention is preferably <10° C., more preferably <0° C., especially preferably between −5 and −30° C. The glass transition temperature of polymers or of polymer blocks in block copolymers is determined in accordance with the invention by dynamic scanning calorimetry (DSC). For this purpose, about 5 mg of an untreated polymer sample is weighed into an aluminum boat (volume 25 μl) and closed with a perforated lid. A DSC 204 F1 from Netzsch is used for the measurement. The measurement is done under nitrogen for inertization. The sample is first cooled down to −150° C., then heated up at a heating rate of 10 K/min to +150° C., and cooled down again to −150° C. The subsequent second heating curve is run again at 10 K/min and the change in heat capacity is recorded. Glass transitions are recognized as steps in the thermogram.

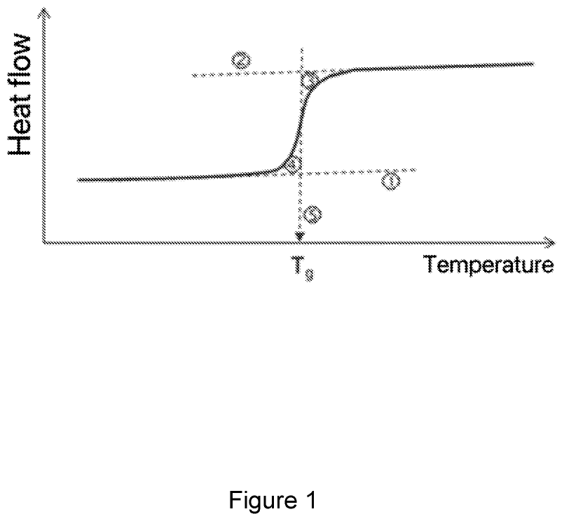

The glass transition temperature is obtained as follows (see FIG. 1):

The respective linear region of the measurement curve before and after the step is extended in the direction of rising temperatures (area before the step) or falling temperatures (area after the step) (tangents \textcircled{1} and \textcircled{2}). In the region of the step, a line of best fit \textcircled{5} is run parallel to the ordinate such that it intersects with both tangents, specifically in such a way as to form two equal areas \textcircled{3} and \textcircled{4} (between the respective tangent, the line of best fit and the measurement curve). The point of intersection of the line of best fit thus positioned with the measurement curve gives the glass transition temperature.

The poly(meth)acrylate in the pressure sensitive adhesive of the invention preferably contains at least one partly polymerized functional monomer which is more preferably reactive with epoxy groups to form a covalent bond. Most preferably, the partly polymerized functional monomer which is more preferably reactive with epoxy groups to form a covalent bond contains at least one functional group selected from the group consisting of carboxylic acid groups, sulfonic acid groups, phosphonic acid groups, hydroxy groups, acid anhydride groups, epoxy groups and amino groups; it especially contains at least one carboxylic acid group. Extremely preferably, the poly(meth)acrylate in the pressure sensitive adhesive of the invention contains partly polymerized acrylic acid and/or methacrylic acid. All the groups mentioned have reactivity with epoxy groups, which means that the poly(meth)acrylate is advantageously amenable to thermal crosslinking with introduced epoxides.

The poly(meth)acrylate in the pressure sensitive adhesive of the invention can preferably be derived from the following monomer composition:
a) 30% to 75% by weight of at least one acrylic ester of the formula (I)

CH₂═CH—C(O)OR¹ (I)
in which R¹ is a linear or branched alkyl group having 1 to 10 carbon atoms;
b) 20% to 65% by weight of at least one acrylic ester of the formula (II)

CH₂═CH—C(O)OR² (II)
in which R² is a phenoxyalkyl radical;
c) 0% to 40% by weight of at least one acrylic ester of the formula (III)

CH²═C(O)OR³ (III)
in which R³ is an alkyldiglycol radical or an alkoxyalkyl radical;
d) 0.5% to 10% by weight of at least one acrylate monomer of the formula (IV)

CH²═CH—C(O)OR⁴ (IV)
in which R4 is a hydrogen atom or a hydroxyalkyl radical having 1 to 4 carbon atoms.

As has been found, such polyacrylates have not only good pressure sensitive adhesion properties but also high chemical stability, and are therefore of very good suitability as base material for a pressure sensitive adhesive of the invention.

R¹ in formula (I) is preferably a radical selected from the group consisting of methyl, n-butyl and 2-ethylhexyl radicals, more preferably from n-butyl and 2-ethylhexyl radicals. Most preferably, R¹ in formula (I) is an n-butyl radical.

R2 in formula (II) is preferably a phenoxyethyl radical, especially a 2-phenoxyethyl radical. Preferably, the parent monomer composition of the poly(meth)acrylate in the pressure sensitive adhesive of the invention comprises phenoxyethyl acrylate to an extent of 22% to 60% by weight.

R³ in formula (III) is preferably an ethyldiglycol radical or a methoxyethyl radical. Preferably, the parent monomer composition of the poly(meth)acrylate in the pressure sensitive adhesive of the invention comprises monomers c) to an extent of 1% to 40% by weight.

R⁴ in formula (IV) is preferably a hydrogen atom.

In one embodiment, the poly(meth)acrylate in the pressure sensitive adhesive of the invention is derivable from the following monomer composition: n-butyl acrylate to an extent of 30% to 55% by weight, methyl acrylate to an extent of 0% to 25% by weight, ethyldiglycol acrylate to an extent of 0% to 40% by weight, methoxyethyl acrylate to an extent of 0% to 25% by weight, phenoxyethyl acrylate to an extent of 20% to 55% by weight and acrylic acid to an extent of 1% to 5% by weight.

More preferably, the poly(meth)acrylate in the pressure sensitive adhesive of the invention is derivable from the following monomer composition: n-butyl acrylate to an extent of 40% to 50% by weight, methyl acrylate to an extent to 15% to 25% by weight, phenoxyethyl acrylate to an extent of 20% to 40% by weight and acrylic acid to an extent of 1% to 5% by weight.

If the pressure sensitive adhesive of the invention comprises two or more poly(meth)acrylates, preferably all poly(meth)acrylates are derivable from one of the above-described monomer compositions.

The poly(meth)acrylates can in principle be prepared using any free-radical or free-radically controlled polymerizations, and likewise combinations of different polymerization methods. As well as conventional, free-radical polymerization, these are, for example, also ATRP, nitroxide/TEMPO-controlled polymerization or the RAFT process. The poly(meth)acrylates can be prepared by copolymerization of the monomers using customary polymerization initiators and optionally chain transfer agents, by polymerization at the customary temperatures in bulk, in emulsion, for example in water or liquid hydrocarbons, or in solution.

The poly(meth)acrylates are preferably prepared by copolymerizing the monomers in solvents, more preferably in solvents having a boiling range of 50 to 150° C., especially of 60 to 120° C., using 0.01% to 5% by weight, especially 0.1% to 2% by weight, based in each case on the total weight of the monomers, of polymerization initiators.

All customary initiators are suitable in principle. Examples of free-radical sources are peroxides, hydroperoxides and azo compounds, for example dibenzoyl peroxide, cumene hydroperoxide, cyclohexanone peroxide, di-t-butyl peroxide, cyclohexylsulfonylacetyl peroxide, diisopropyl percarbonate, t-butyl peroctoate and benzpinacol. Preferred free-radical initiators are 2,2′-azobis(2-methylbutyronitrile) or 2,2′-azobis(2-methylpropionitrile) (2,2′-azobisisobutyronitrile).

Preferred solvents for the preparation of the poly(meth)acrylates are alcohols such as methanol, ethanol, n-and isopropanol, n-and isobutanol, especially isopropanol and/or isobutanol; hydrocarbons such as toluene and especially benzine with a boiling range from 60 to 120° C.; ketones, especially acetone, methyl ethyl ketone, methyl isobutyl ketone, esters such as ethyl acetate, and mixtures of the aforementioned solvents. Particularly preferred solvents are mixtures containing isopropanol in amounts of 2% to 15% by weight, especially of 3% to 10% by weight, based in each case on the solvent mixture used.

The production (polymerization) of the poly(meth)acrylates is preferably followed by a concentration step, and the further processing of the poly(meth)acrylates, especially the blending with the further constituents of the pressure sensitive adhesive of the invention, is essentially solvent-free. The concentration of the polymer can be accomplished in the absence of crosslinker and accelerator substances. But it is also possible to add one of these compound classes to the polymer even before the concentration, such that the concentration is then effected in the presence of this/these substance(s).

After the concentration step, the polymers can be transferred to a compounder. The concentration and compounding may optionally also take place in the same reactor.

The weight-average molecular weights Mw of the poly(meth)acrylates are preferably within a range from 20000 to 2000000 g/mol; very preferably within a range from 100000 to 1500000 g/mol, exceptionally preferably within a range from 150000 to 1000000 g/mol.

For this purpose, it may be advantageous to conduct the polymerization in the presence of suitable chain transfer agents such as thiols, halogen compounds and/or alcohols in order to establish the desired average molecular weight.

The number-average molar mass Mₙ and weight-average molar mass M_{w} figures in this document relate to determination by gel permeation chromatography (GPC), which is known per se. The determination is effected on a 100 μl clear-filtered sample (sample concentration 4 g/l). The eluent used is tetrahydrofuran with 0.1% by volume of trifluoroacetic acid. The measurement is effected at 25° C.

The pre-column used is a column of the PSS-SDV type, 5 μm, 10³ Å, 8.0 mm*50 mm (figures here and hereinafter in the following sequence: type, particle size, porosity, internal diameter*length; 1 Å=10⁻¹⁰ m). Separation is accomplished using a combination of columns of the PSS-SDV type, 5 μm, 10³ Å, and 10⁵ Å and 10⁶ Å, each with 8.0 mm*300 mm (columns from Polymer Standards Service; detection by means of Shodex RI71 differential refractometer). The flow rate is 1.0 ml per minute. Calibration in effected by means of the commercially available ReadyCal poly (styrene) high kit from PSS Polymer Standard Service GmbH, Mainz. This is converted universally to polymethylmethacrylate (PMMA) using the Mark-Houwink parameters K and alpha, and so the data are reported in PMMA mass equivalents.

The poly(meth)acrylates preferably have a K value of 30 to 90, more preferably of 40 to 70,measured in toluene (1% solution, 21° C.). Fikentscher's K value is a measure of the molecular weight and viscosity of polymers.

The principle of the method for determination of the K value is based on the determination of the relative solution viscosity by capillary viscometry. For this purpose, the test substance is dissolved in toluene by shaking for 30 minutes, so as to obtain a 1% solution. In a Vogel-Ossag viscometer, at 25° C., the flow time is measured and this is used to determine the relative viscosity of the sample solution with respect to the viscosity of the pure solvent. According to Fikentscher [P. E. Hinkamp, Polymer, 1967, 8, 381], it is possible to read off the K value from tables (K=1000 k).

The poly(meth)acrylate in the pressure sensitive adhesive of the invention preferably has a polydispersity PD<4 and hence a relatively narrow molecular weight distribution. Adhesives based thereon, in spite of a relatively low molecular weight after crosslinking, have particularly good shear strength. Moreover, the relatively low polydispersity enables easier processing from the melt since the flow viscosity is lower compared to a poly(meth)acrylate of broader distribution with largely the same application properties. Poly(meth)acrylates having a narrow distribution can advantageously be prepared by anionic polymerization or by controlled free-radical polymerization methods, the latter being of particularly good suitability. It is also possible to prepare corresponding poly(meth)acrylates via N-oxyls. In addition, it is advantageously possible to use atom transfer radical polymerization (ATRP) for synthesis of narrow-distribution poly(meth)acrylates, preferably using monofunctional or difunctional, secondary or tertiary halides as initiator, and complexes of Cu, Ni, Fe, Pd, Pt, Ru, Os, Rh, Co, Ir, Ag or Au for abstraction of the halides. RAFT polymerization is also suitable.

The poly(meth)acrylates in the pressure sensitive adhesive of the invention have preferably been crosslinked. They have more preferably been thermally crosslinked, meaning that they have been crosslinked by linkage reactions—especially by addition or substitution reactions—of functional groups present therein with specially added crosslinker substances. It is possible to use any thermal crosslinkers which
both assure a sufficiently long processing time, such that there is no gelation during the processing operation, especially the extrusion operation,
and lead to rapid postcrosslinking of the polymer to the desired degree of crosslinking at lower temperatures than the processing temperature, especially at room temperature.

Thermal crosslinking can be conducted under significantly milder conditions than, for example, radiation-induced crosslinking, which can occasionally also have a destructive effect. In principle, however, it is also possible in the context of the invention to bring about crosslinking of the poly(meth)acrylates exclusively or additionally by means of actinic radiation, where it is optionally possible to add required or promoting crosslinker substances, for example UV crosslinkers.

The poly(meth)acrylates in the pressure sensitive adhesive of the invention have preferably been crosslinked by means of epoxide(s) or by means of one or more substance(s) containing epoxy groups. The substances containing epoxy groups are especially polyfunctional epoxides, i.e. those having at least two epoxy groups; the result is accordingly indirect linkage of the units of the poly(meth)acrylates that bear the functional groups. The substances containing epoxy groups may be either aromatic or aliphatic compounds.

Polyfunctional epoxides of excellent suitability are oligomers of epichlorohydrin, epoxy ethers of polyhydric alcohols, especially ethylene glycols, propylene glycols and butylene glycols, polyglycols, thiodiglycols, glycerol, pentaerythritol, sorbitol, polyvinylalcohol, polyallylalcohol and the like; epoxy ethers of polyhydric phenols, especially of resorcinol, hydroquinone, bis(4-hydroxyphenyl)methane, bis(4-hydroxy-3-methylphenyl)methane, bis(4-hydroxy-3,5-dibromophenyl)methane, bis(4-hydroxy-3,5-difluorophenyl)methane, 1,1-bis(4-hydroxyphenyl)ethane, 2,2-bis(4-hydroxyphenyl)propane, 2,2-bis(4-hydroxy-3-methylphenyl)propane, 2,2-bis(4-hydroxy-3-chlorophenyl)propane, 2,2-bis(4-hydroxy-3,5-dichlorophenyl)propane, 2,2-bis(4-hydroxy-3,5-dichlorophenyl)propane, bis (4-hydroxyphenyl)phenylmethane, bis(4-hydroxyphenyl)phenylmethane, bis(4-hydroxyphenyl)diphenylmethane, bis(4-hydroxyphenyl)-4′-methylphenylmethane, 1,1-bis(4-hydroxyphenyl)-2,2,2-trichloroethane, bis(4-hydroxyphenyl)-(4-chlorophenyl)methane, 1, 1-bis(4-hydroxyphenyl)cyclohexane, bis(4-hydroxyphenyl)-cyclohexylmethane, 4,4′-dihydroxydiphenyl, 2,2′-dihydroxydiphenyl, 4,4′-dihydroxydiphenyl sulfone and the hydroxyethyl ether thereof; phenol-formaldehyde condensation products such as phenol alcohols and phenol-aldehyde resins; S- and N-containing epoxides, for example N,N-diglycidylaniline and N, N′-dimethyldiglycidyl-4,4-diaminodiphenylmethane; and epoxides that have been prepared by customary methods from polyunsaturated carboxylic acids or monounsaturated carboxylic esters of unsaturated alcohols; glycidyl esters, and polyglycidyl esters, which can be obtained by polymerization or copolymerization of glycidyl esters of unsaturated acids or from other acidic compounds, for example from cyanuric acid, diglycidyl sulfide or cyclic trimethylene trisulfone or derivatives thereof.

Very suitable ethers are, for example, butane-1,4-diol diglycidyl ether, polyglycerol-3 glycidyl ether, cyclohexanedimethanol diglycidyl ether, glycerol triglycidyl ether, neopentyl glycol diglycidyl ether, pentaerythrityl tetraglycidyl ether, hexane-1,6-diol diglycidyl ether, polypropylene glycol diglycidyl ether, trimethylolpropane triglycidyl ether, pentaerythritol tetraglycidyl ether, bisphenol A diglycidyl ether and bisphenol F diglycidyl ether.

Further preferred epoxides are cycloaliphatic epoxides such as 3,4-epoxycyclohexylmethyl 3,4-epoxycyclohexanecarboxylate.

More preferably, the poly(meth)acrylates are crosslinked by means of a crosslinker-accelerator system (“crosslinking system”), in order to obtain better control over the processing time, crosslinking kinetics and degree of crosslinking. The crosslinker-accelerator system preferably comprises at least one substance containing epoxy groups as crosslinker, and at least one substance having accelerating action at a temperature below the melting temperature of the polymer to be crosslinked for crosslinking reactions by means of compounds containing epoxy groups as accelerator.

Accelerators used in accordance with the invention are more preferably amines. These should be regarded in a formal sense as substitution products of ammonia; in the formulas that follow, the substituents are represented by “R” and especially include alkyl and/or aryl radicals. Particular preference is given to using those amines that enter into only a low level of reactions, if any, with the polymers to be crosslinked.

In principle, accelerators chosen may be primary (NRH₂), secondary (NR₂H) or else tertiary amines (NR₃), and of course also those having multiple primary and/or secondary and/or tertiary amino groups. Particularly preferred accelerators are tertiary amines, for example triethylamine, triethylenediamine, benzyldimethylamine, dimethylaminomethylphenol, 2,4,6-tris(N,N-dimethylaminomethyl)phenol and N,N′-bis(3-(dimethylamino)propyl)urea. Further preferred accelerators are polyfunctional amines, for example diamines, triamines and/or tetramines, e.g. diethylenetriamine, triethylenetetramine, trimethylhexamethylenediamine.

Further preferred accelerators are amino alcohols, especially secondary and/or tertiary amino alcohols, where, in the case of multiple amino functionalities per molecule, preferably at least one amino functionality is and more preferably all amino functionalities are secondary and/or tertiary. Particularly preferred accelerators of this kind are triethanolamine, N,N-bis(2-hydroxypropyl)ethanolamine, N-methyldiethanolamine, N-ethyldiethanolamine, 2-aminocyclohexanol, bis(2-hydroxycyclohexyl)methylamine, 2-(diisopropylamino)ethanol, 2-(dibutylamino)ethanol, N-butyldiethanolamine, N-butylethanolamine, 2-[bis(2-hydroxyethyl)amino]-2-(hydroxymethyl)propane-1,3-diol, 1-[bis (2-hydroxyethyl)amino]-2-propanol, triisopropanolamine, 2-(dimethylamino)ethanol, 2-(diethylamino)ethanol, 2-(2-dimethylaminoethoxy)ethanol, N,N,N′-trimethyl-N′-hydroxyethyl bisaminoethyl ether, N,N,N′-trimethylaminoethylethanolamine and N,N,N′-trimethylaminopropylethanolamine.

Further suitable accelerators are pyridine, imidazoles, for example 2-methylimidazole, and 1,8-diazabicyclo[5.4.0]undec-7-ene. It is also possible to use cycloaliphatic polyamines as accelerator. Also suitable are phosphorus-based accelerators such as phosphines and/or phosphonium compounds, for example triphenylphosphine or tetraphenylphosphonium tetraphenylborate.

It is also possible to use quaternary ammonium compounds as accelerator; examples are tetrabutylammonium hydroxide, cetyltrimethylammonium bromide and benzalkonium chloride.

Preferred thermal crosslinkers aside from the covalent crosslinkers, such as, in particular, epoxides, isocyanates and/or aziridines, are also coordinating crosslinkers, more preferably metal chelates, especially aluminum, titanium, zirconium and/or iron chelates. It is also possible to use combinations of different crosslinkers, for example a combination of one or more epoxides with one or more metal chelates.

Very particularly preferred metal chelates are aluminum chelates, for example aluminum (III) acetylacetonate. These crosslinkers are preferably used in an amount of 0.01 to 0.1 part by weight, more preferably of 0.02 to 0.08 part by weight, based in each case on 100 parts by weight of the poly(meth)acrylate (in solvent-free form).

Very particularly preferred thermal crosslinkers are epoxides, especially those having tertiary amine functions, for example tetraglycidylmetaxylenediamine (N, N,N′,N′-tetrakis(oxiranylmethyl)-1,3-benzenedimethanamine). These compounds are preferably used in an amount of 0.03 to 0.1 part by weight, more preferably of 0.04 to 0.07 part by weight, based in each case on 100 parts by weight of the polyacrylate (in solvent-free form).

The pressure sensitive adhesive of the invention further comprises at least one vinylaromatic-butadiene block copolymer and at least one vinylaromatic-isoprene block copolymer. It is possible in each case for a (single) vinylaromatic-butadiene block copolymer and vinylaromatic-isoprene block copolymer to be included, but two or more vinylaromatic-butadiene block copolymers and vinylaromatic-isoprene block copolymers may also be included independently of one another. The pressure sensitive adhesive of the invention preferably comprises vinylaromatic-butadiene block copolymers and vinylaromatic-isoprene block copolymers to a total extent of 20% to 30% by weight, based on the total weight of the pressure sensitive adhesive. The plural form “vinylaromatic-butadiene block copolymers and vinylaromatic-isoprene block copolymers” explicitly also includes the case that the pressure sensitive adhesive of the invention in each case comprises just one vinylaromatic-butadiene block copolymer and/or vinylaromatic-isoprene block copolymer.

Block copolymers of vinylaromatics and conjugated dienes are known in principle to the person skilled in the art. Both the vinylaromatic-butadiene block copolymer and the vinylaromatic-isoprene block copolymer in the pressure sensitive adhesive of the invention may fundamentally have a structure of the A-B, A-B-A, (A-B)ₙ, (A-B)ₙX or (A-B-A)ₙX form in which
the A blocks are independently a vinylaromatic block;
the B blocks are independently a polybutadiene or polyisoprene block;
X represents the residue of a coupling reagent or initiator and
n is an integer ≥2.

The pressure sensitive adhesive of the invention may also contain mixtures of different vinylaromatic block copolymers having a structure as above.

The vinylaromatic block copolymers of the synthetic rubber component in the pressure sensitive adhesive of the invention thus comprise one or more rubbery blocks B (soft blocks) and one or more glassy blocks A (hard blocks). More preferably at least one and most preferably both of the vinylaromatic block copolymers in the pressure sensitive adhesive of the invention are a block copolymer having an A-B or A-B-A structure where A and B have the definitions above.

Preferably, the vinylaromatic-isoprene block copolymer is accordingly a linear block copolymer; likewise preferably, the vinylaromatic-butadiene block copolymer is a linear block copolymer; more preferably, both the vinylaromatic-butadiene block copolymer and the vinylaromatic-isoprene block copolymer are linear block copolymers. Linear block copolymers have been found to be advantageous for the adhesive properties of the pressure sensitive adhesive of the invention.

The vinylaromatic-butadiene block copolymer preferably has a vinylaromatic content of at least 25%, more preferably of at least 28%, especially of at least 30%. According to the findings obtained in the context of the invention, this has an advantageous effect on the internal strength (cohesion) of the pressure sensitive adhesive.

The vinylaromatic-isoprene block copolymer, by contrast, preferably has a vinylaromatic content of not more than 25%, more preferably of not more than 17%. This has been found to be particularly advantageous for the shock resistance of the pressure sensitive adhesive.

In one embodiment, the vinylaromatic-isoprene block copolymer is a radial block copolymer having a vinylaromatic content of not more than 25%, especially of not more than 20%. Such block copolymers have been found to be advantageous with regard to bond strength and internal strength.

The vinylaromatic-isoprene block copolymer preferably has a diblock content of >50%, more preferably of >65%, especially of >75%. Likewise preferably, the vinylaromatic-butadiene block copolymer has a diblock content of >50%, more preferably of >65%, especially of >75%. High diblock contents, especially of the vinylaromatic-butadiene copolymer, have been found to be advantageous for the adhesive properties of the pressure sensitive adhesive. More preferably, both the vinylaromatic-isoprene block copolymer and the vinylaromatic-butadiene block copolymer have a diblock content of >50%, more preferably of >65%, especially of >75%.

The vinylaromatic in the vinylaromatic block copolymers of the synthetic rubber component in the pressure sensitive adhesive of the invention is preferably styrene; preferably, the vinylaromatic blocks of the vinylaromatic block copolymers are accordingly polystyrene blocks. Preferably, the vinylaromatic-butadiene block copolymer is thus a styrene-butadiene block copolymer, and the vinylaromatic-isoprene block copolymer is a styrene-isoprene block copolymer. In particular, the vinylaromatic-butadiene block copolymer is a styrene-butadiene-styrene block copolymer (SBS), and the vinylaromatic-isoprene block copolymer is a styrene-isoprene-styrene block copolymer (SIS).

As has been shown, in pressure sensitive adhesives of the invention, the poly(meth)acrylate or the totality of the poly(meth)acrylates is generally present as matrix or continuous phase, in which the vinylaromatic block copolymers are embedded as disperse phase. The synthetic rubber component is therefore also referred to hereinafter as synthetic rubber phase. The synthetic rubber phase may exist in different morphologies in the poly(meth)acrylate matrix.

The poly(meth)acrylate and the mixture of two or more vinylaromatic block copolymers are accordingly preferably respectively homogeneous phases. The poly(meth)acrylates and vinylaromatic block copolymers present in the pressure sensitive adhesives are preferably not mutually miscible to homogeneity at 23° C. The pressure sensitive adhesive of the invention is thus preferably in at least biphasic morphology at least microscopically and at least at room temperature. More preferably, poly(meth)acrylate(s) and vinylaromatic block copolymers are not homogeneously miscible with one another within a temperature range from 0° C. to 50° C., especially from −30° C. to 80° C., and so the pressure sensitive adhesive is in at least biphasic form at least microscopically within these temperature ranges.

Components in the context of this document are defined as “not homogeneously miscible with one another” if, even after intimate mixing, the formation of at least two stable phases in physical and/or chemical terms can be detected at least microscopically, where one phase is rich in one component and the second phase is rich in the other component. Existence of negligibly small amounts of one component in the other that does not constitute a barrier to development of polyphasicity is regarded here as immaterial.

An example of a suitable analysis system for phase separation is scanning electron microscopy. Phase separation can, however, also be recognized, for example, in that the different phases have two independent glass transition temperatures in dynamic scanning calorimetry (DSC). Phase separation exists in accordance with the invention when it can be shown unambiguously by at least one of the analysis methods.

Within the synthetic rubber-rich domains, additional polyphasicity may additionally be present as fine structure, where the vinylaromatic blocks form one phase and the isoprene and/or butadiene blocks a second phase.

The weight ratio of vinylaromatic-butadiene block copolymer(s): vinylaromatic-isoprene block copolymer(s) is preferably 1.3:1 to 2.3:1, more preferably 1.5:1 to 2.1:1. With these weight ratios, particularly good internal strengths in z direction and particularly high shock resistance were observed.

The pressure sensitive adhesive of the invention preferably comprises, as well as the constituents detailed so far, at least one tackifying resin. Tackifying resins and their role in pressure sensitive adhesives are fundamentally known to the person skilled in the art; they are generally also referred to as tackifiers or bond strength boosters. A “tackifying resin” is understood in accordance with the general understanding of the person skilled in the art to mean an oligomeric or polymeric resin that increases autoadhesion (tack, intrinsic tack) of the pressure sensitive adhesive by comparison with the otherwise identical pressure sensitive adhesive that does not contain any tackifier.

The tackifying resin of the pressure sensitive adhesive of the invention is compatible with the synthetic rubber phase. This means that the tackifying resin alters the glass transition temperature of the system obtained after thorough mixing of synthetic rubbers and tackifying resin by comparison with the pure mixture of the synthetic rubbers, although even the mixture of synthetic rubbers and tackifying resin can be assigned only one glass transition temperature. An incompatible tackifying resin would lead to two glass transition temperatures, one of which would be assignable to the synthetic rubber mixture and the other to the resin domains. The glass transition temperature is determined in this connection by calorimetry by DSC (differential scanning calorimetry) as already described herein.

The tackifying resin is preferably a hydrocarbon resin; it is more preferably selected from the group consisting of hydrogenated polymers of dicyclopentadiene; non-hydrogenated or selectively, partially or fully hydrogenated hydrocarbon resins based on C₅, C₅/C₉ or C₉ monomer streams; and polyterpene resins, especially those based on α-pinene and/or on β-pinene and/or on δ-limonene. The hydrocarbon resins preferably have a DACP value of at least 0° C., very preferably of at least 20° C., and/or preferably an MMAP value of at least 40° C., very preferably of at least 60° C. With regard to the determination of DACP and MMAP values, reference is made to C. Donker, PSTC Annual Technical Seminar, Proceedings, pages 149-164, May 2001.

The tackifying resin is most preferably a polyterpene resin, especially based on α-pinene and/or on β-pinene and/or on δ-limonene.

The pressure sensitive adhesive of the invention preferably comprises one or more tackifying resins to an extent of 7% to 25% by weight, based on the total weight of the pressure sensitive adhesive.

The tackifying resin in the pressure sensitive adhesive of the invention is preferably incompatible with the poly(meth)acrylate phase.

In one embodiment, however, the pressure sensitive adhesive of the invention comprises a tackifying resin compatible with the synthetic rubber component and a further tackifying resin compatible with the poly(meth)acrylates. The tackifying resin compatible with the poly(meth)acrylates is preferably a (meth) acrylate resin which is preferably present in the pressure sensitive adhesive to a total extent of <10% by weight. Such an addition improves adhesion to polar bonding substrates.

In one embodiment, the pressure sensitive adhesive of the invention has been foamed. The foaming can in principle be effected by means of any desired chemical and/or physical methods. However, a foamed pressure sensitive adhesive of the invention is preferably obtained by the introduction and subsequent expansion of microballoons. “Microballoons” are understood to mean hollow microbeads that are elastic and hence expandable in their ground state and have a thermoplastic polymer shell. These beads are filled with low-boiling liquids or liquefied gas. The shell material used is especially polyacrylonitrile, PVDC, PVC or polyacrylates. Suitable low-boiling liquids are especially hydrocarbons of the lower alkanes, for example isobutane or isopentane, that are enclosed in the polymer shell as liquefied gas under pressure.

Action on the microballoons, especially thermal action, results in softening of the outer polymer shell. At the same time, the liquid blowing gas present in the shell is converted to its gaseous state. The microballoons expand irreversibly and three-dimensionally. The expansion has ended when the internal and external pressures balance. Since the polymer shell is conserved, a closed-cell foam is thus achieved.

When foaming is effected by means of microballoons, the microballoons may be supplied to the formulation as a batch, paste or unblended or blended powder. Metering points are conceivable, for example, before or after the point of addition of the poly(meth)acrylate, for instance collectively as a powder with the synthetic rubbers or as a paste at a later juncture.

There is a multitude of commercially available types of microballoon that are differentiated essentially by their size (diameter 6 to 45 μm in the unexpanded state) and their required starting temperatures for expansion (75 to 220° C.). Unexpanded microballoon types are also available in the form of an aqueous dispersion having a solids content or microballoon content of about 40% to 45% by weight, and additionally also in the form of polymer-bound microballoons (masterbatches), for example in ethylen-vinyl acetate with a microballoon concentration of about 65% by weight. Both the microballoon dispersions and the masterbatches, like the DU products, are suitable for production of a foamed pressure sensitive adhesive of the invention.

A foamed pressure sensitive adhesive of the invention can also be produced with what are called pre-expanded microballoons. In this group, the expansion takes place before mixing into the polymer matrix. Pre-expanded microballoons are commercially available, for example, under the Dualite® name or with the DE (Dry Expanded) type designation.

The density of a foamed pressure sensitive adhesive of the invention is preferably <1100 kg/m³, more preferably <1000 kg/m³. More preferably, the density of a foamed pressure sensitive adhesive of the invention is 800 to 1000 kg/m³, especially 850 to 970 kg/m³.

Depending on the field of use and desired properties of the pressure sensitive adhesive of the invention, it is possible to add further components and/or additives thereto, in each case alone or in combination with one or more other additives or components.

For example, the pressure sensitive adhesive of the invention may contain pulverulent and granular, especially also abrasive and reinforcing, fillers, dyes and pigments, for example chalks (CaCO₃), titanium dioxide, zinc oxides and/or carbon blacks.

The pressure sensitive adhesive preferably contains one or more forms of chalk as filler, more preferably Mikrosöhl chalks (from Söhlde). In the case of preferred proportions of up to 20% by weight, there is virtually no change in adhesive properties (shear strength at room temperature, immediate bond strength on steel and PE) as a result of the addition of filler. In addition, various organic fillers may be present.

Suitable additives for the pressure sensitive adhesive of the invention are also—chosen independently of other additives—nonexpandable hollow polymer beads, solid polymer beads, hollow glass beads, solid glass beads, hollow ceramic beads, solid ceramic beads and/or solid carbon beads (“carbon microballoons”).

In addition, the pressure sensitive adhesive of the invention may contain low-flammability fillers, for example ammonium polyphosphate; electrically conductive fillers, for example conductive carbon black, carbon fibers and/or silver-coated beads; thermally conductive materials, for example boron nitride, aluminum oxide, silicon carbide; ferromagnetic additives, for example iron (III) oxides; organic renewable raw materials, for example ground wood, organic and/or inorganic nanoparticles, fibers; compounding agents, aging stabilizers, light stabilizers and/or antiozonants.

Plasticizers may optionally be present. Plasticizers that may be metered in may include, for example, (meth) acrylate oligomers, phthalates, cyclohexanedicarboxylic esters, water-soluble plasticizers, plasticizing resins, phosphates or polyphosphates.

The addition of silicas, advantageously of precipitated silica having surface modification by dimethyldichlorosilane, may be utilized in order to adjust the thermal shear strength of the pressure sensitive adhesive.

A process for producing a pressure sensitive adhesive of the invention may first comprise concentration of the polyacrylate solution or dispersion resulting from the polymer production. The concentration of the polymer may take place in the absence of crosslinker and accelerator substances. But it is also possible to add not more than one of these substances to the polymer even before the concentration, such that the concentration is then effected in the presence of this/these substance(s).

The synthetic rubbers and optionally one or more tackifying resins may be added to a compounder via a solids metering device. A side feeder can be used to introduce the concentrated and optionally already molten poly(meth)acrylate into the compounder. In particular embodiments of the method, it is also possible that concentration and compounding take place in the same reactor. The resins may also be fed in by means of a resin melting unit and a further side feeder at a different position in the process, for example after introduction of synthetic rubbers and poly(meth)acrylate.

Further additives and/or plasticizers may likewise be fed in as solids or in molten form or else as a batch in combination with another formulation component.

In particular, the compounder used may be an extruder. The polymers are preferably in molten form in the compounder, either because they are already added in the molten state or in that they are heated to melting in the compounder. Advantageously, the polymers in the compounder are kept in the melt by heating.

If accelerator substances are used for the crosslinking of the poly(meth)acrylate, they are preferably added only shortly before the further processing of the largely ready-blended composition, especially only shortly before coating or shaping in some other way. The time window for the addition before the coating is especially guided by the pot life available, i.e. the processing time in the melt, without disadvantageous alteration of the properties of the resulting product.

The crosslinkers, for example epoxides, and the accelerators may also both be added shortly before the further processing of the composition, i.e. advantageously in the phase as described above for the accelerators. For this purpose, it is advantageous when crosslinkers and accelerators are introduced into the process simultaneously at one and the same point, optionally as an epoxide-accelerator blend. In principle, it is also possible to switch the times of addition or addition sites for crosslinker and accelerator in the executions described above, such that the accelerator is added before the crosslinker substances.

Compounding of the composition may be followed by further processing thereof, especially coating onto a permanent or temporary carrier. A permanent carrier remains bonded to the adhesive layer in use, whereas the temporary carrier is removed later on in the processing operation, for example in the course of finishing of the adhesive tape, or is removed from the adhesive layer on or shortly before the final use of the pressure sensitive adhesive.

The self-adhesive compositions can be coated with the hotmelt coating nozzles that are known in principle to the person skilled in the art, or preferably with roll coating systems, also called coating calenders. The coating calenders may advantageously consist of two, three, four or more rolls.

Preferably, at least one of the rolls has been provided with a nonstick roll surface. Preferably all rolls of the calender that come into contact with the pressure sensitive adhesive have been given a nonstick finish. The nonstick roll surface used is preferably a steel-ceramic-silicone composite material. Such roll surfaces are resistant to thermal and mechanical stresses.

It has been found to be particularly advantageous when roll surfaces having a surface structure are used, especially in such a way that the face does not establish complete contact with the composition layer to be processed, but that the contact area is small by comparison with a smooth roll. Structured rolls such as patterned metal rolls are particularly favorable, for example patterned steel rolls.

If the pressure sensitive adhesive of the invention is to be foamed, the foaming can in principle be effected either in the compounder or after the composition has been deployed. For the purposes of facilitated processibility of the pressure sensitive adhesive composition, it may be preferable first to produce the composition in a hotmelt method, for example as described above, and to incorporate a foaming agent, for example microballoons, in the course thereof, but to conduct the foaming or expansion of the composition only after it has left the compounder. As has been shown, it is possible in this way to achieve a reduction in surface roughness specifically for compositions foamed with microballoons. In the case of such a procedure, however, it is necessary to ensure that the composition or the microballoons do not already expand within the compounder. This can be achieved by means of an appropriate pressure-temperature controller in the compounder.

The invention further provides an adhesive tape comprising at least one layer of a pressure sensitive adhesive of the invention. Pressure sensitive adhesives of the invention are particularly suitable for the formation of high layer thicknesses. The thickness of the above layer of a pressure sensitive adhesive of the invention is therefore preferably 100 μm to 5000 μm, more preferably 150 μm to 3000 μm, especially 200 μm to 2500 μm, for example 500 μm to 2000 μm.

The adhesive tape of the invention preferably consists of a layer of a pressure sensitive adhesive of the invention. The tape in this case is what is called a transfer adhesive tape. However, the pressure sensitive adhesive may alternatively take the form of a carrier layer of a single- or double-sided adhesive tape or form at least one of the touch-tacky outer layers of a carrier-containing single-or double-sided adhesive tape. A release liner as typically applied thereto for (temporary) protection of pressure sensitive adhesives is not considered to be a constituent of an adhesive tape. Accordingly, the adhesive tape of the invention may consist solely of a layer of a pressure sensitive adhesive of the invention, even if it is covered with a release liner.

The invention further provides for the use of a pressure sensitive adhesive of the invention or of an adhesive tape of the invention as bonding means in the manufacture of electronic, optical or precision-mechanical devices, especially portable electronic, optical or precision-mechanical devices.

Such portable devices are in particular:
cameras, digital cameras, photographic accessories (such as exposure meters, flashguns, diaphragms, camera casings, lenses, etc.), film cameras, video cameras; microcomputers (portable computers, pocket computers, pocket calculators), laptops, notebooks, netbooks, ultrabooks, tablet computers, handhelds, electronic diaries and organizers (called “personal digital assistants”, PDAS, palmtops), modems;
computer accessories and operating units for electronic devices, such as mice, drawing pads, graphics tablets, microphones, speakers, games consoles, gamepads, remote controls, remote operating devices, touchpads;
monitors, displays, screens, touch-sensitive screens (sensor screens, touchscreen devices), projectors;
reading devices for electronic books (“e-books”);
mini TVs, pocket TVs, devices for playing films, video players; radios (including mini and pocket radios), Walkmans, Discmans, music players for, e.g., CD, DVD, Blu-ray, cassettes, USB, MP3; headphones; cordless telephones, cellphones, smartphones, two-way radios, hands-free telephones, devices for summoning people (pagers, bleepers);
mobile defibrillators, blood sugar meters, blood pressure monitors, step counters, pulse meters;
torches, laser pointers;
mobile detectors, optical magnifiers, binoculars, night vision devices, GPS devices, navigation devices, portable interface devices for satellite communication;
data storage devices (USB sticks, external hard drives, memory cards); and
wristwatches, digital watches, pocket watches, fob watches, and stopwatches.

A pressure sensitive adhesive of the invention or an adhesive tape of the invention is used more particularly as bonding means in the production of smartphones (cellphones), tablets, notebooks, cameras, video cameras, keyboards or touchpads.

### EXAMPLES

### Test Methods

### Test 1: Immediate Bond Strength on Plastic

Bond strength on plastic was determined under test conditions of temperature 23° C. +/−1° C. and relative humidity 50% +/−5%; the plastic substrate used was a sheet of PBT reinforced with 30% glass fibers and having a surface roughness of 1 μm.

The test sheet was first wiped with ethanol before the measurement for the purpose of cleaning and conditioning and then left to stand under air for 5 minutes for the solvent to evaporate off. The side of the single-layer adhesive tape remote from the test substrate was then covered with 36 μm of etched PET film, which prevented the sample from stretching in the course of measurement. Thereafter, the test specimen was rolled onto the plastic substrate. For this purpose, a 2 kg rubber roll was rolled over twice back and forth at a rolling speed of 10 m/min. Immediately after it had been rolled on, the adhesive tape was pulled off the plastic substrate at an angle of 180°, measuring the force required for the purpose with a Zwick tensile tester. The measurement results are reported in N/cm and are averaged from three individual measurements.

A good result is considered to be a bond strength of 5.5 N/cm or greater.

### Test 2: Stretching in Z Direction (Static Load)

What is called the static load test method serves both to determine the holding power and to determine the deflection of the adhesive tape in z direction.

A square, frame-shaped sample was cut out of the adhesive tape to be examined (external dimensions 33 mm×33 mm; edge width 2 mm; internal dimensions (window cutout) 29 mm×29 mm). This sample was stuck to an acetone-cleaned steel frame (external dimensions 45 mm×45 mm; edge width 10 mm; internal dimensions (window cutout) 25 mm×25 mm). Stuck to the other side of the adhesive tape was an acetone-cleaned steel window (external dimensions 35 mm×35 mm). The bonding of steel frame, adhesive tape frame and steel window was effected in such a way that the geometric centers and the diagonals were each superposed on one another (corner-to-corner). The bond area was 248 mm2. The bond was pressed at 248 N for 5 s and stored at 23° C./50% relative humidity for 72 hours.

On the opposite side of the steel window from the bond, a suitable adhesive tape was used to apply what is called a T block with base dimensions of 20×20 mm, made of steel, over its full area. The resultant test specimen was suspended in a stand with the T block pointing downward, with the test specimen resting on the frame of the steel frame and the window with the T block accordingly pointing downward without contact with the stand. The test is started by suspending a 1000 g weight on the T block. Immediately thereafter, the deflection of the adhesive tape is determined as the starting value. For this purpose, a slide rule is used to measure the distance between the outside of the steel frame and the inside of the window at all four corners (i.e. material thickness of the steel frame +adhesive bond). This measurement is repeated after 2 h, 5 h, 24 h, 48 h, 72 h, 144 h and 196 h.

In each case, the average of the four measurement points is used to determine the extent to which the deflection of the adhesive bond has changed and whether the adhesive bond is still intact.

The result noted is both the hold time and the deflection of three test specimens in each case.

Good results show a deflection of ≤0.02 mm and a hold performance of >168 h.

### Test 3: DuPont Test in Z Direction (Puncture Resistance)

A square, frame-shaped sample was cut out of the adhesive tape (pressure sensitive adhesive strip) to be examined (external dimensions 33 mm×33 mm; edge width 2.0 mm;

internal dimensions (window cutout) 29 mm×29 mm). This sample was stuck to a polycarbonate (PC) frame (external dimensions 45 mm×45 mm; edge width 10 mm; internal dimensions (window cutout) 25 mm×25 mm; thickness 3 mm). Stuck to the other side of the adhesive tape was a PC window of 35 mm×35 mm. The bonding of PC frame, adhesive tape frame and PC window was effected in such a way that the geometric centers and the diagonals were each superposed on one another (corner-to-corner). The bond area was 248 mm². The bond was pressed at 248 N for 5 s and stored at 23° C./50% relative humidity for 24 hours.

Immediately after the storage, the adhesive bond composed of PC frame, adhesive tape and PC window was clamped by the protruding edges of the PC frame into a sample holder in such a way that the composite was aligned horizontally and the PC window was beneath the frame. The sample holder was then inserted centrally into the receptacle provided in the “DuPont Impact Tester”. The impact head of weight 190 g was inserted in such a way that the circular impact geometry with diameter 20 mm was central and flush on the window side the PC window.

A weight with a mass of 150 g that was guided on to guide rails was allowed to drop from a height of 5 cm onto the composite composed of sample holder, sample and impact head arranged in this way (measurement conditions 23° C., 50% relative humidity). The height of the falling weight was increased in 5 cm steps until the impact energy introduced destroyed the sample as a result of the impact stress and the PC window became detached from the PC frame.

In order to be able to compare experiments with different samples, the energy was calculated as follows:

$$E [ J ] = height [ m ] * weight [ kg ] * 9.81 m / {s}^{2}$$

Five samples per product were tested, and the average energy was reported as index of impact resistance.

### Test 4: Drop Tower Test (Impact Resistance)

The drop tower test method as an instrumented drop system test likewise serves for measurement of impact resistance.

A square, frame-shaped sample was cut out of the adhesive tape (pressure sensitive adhesive strip) to be examined (external dimensions 33 mm×33 mm; edge width 2.0 mm; internal dimensions (window cutout) 29 mm×29 mm). This sample was stuck to an acetone-cleaned steel frame (external dimensions 45 mm×45 mm; edge width 10 mm; internal dimensions (window cutout) 25 mm×25 mm). Stuck to the other side of the adhesive tape was an acetone-cleaned steel window (external dimensions 35 mm×35 mm). The bonding of steel frame, adhesive tape frame and steel window was effected in such a way that the geometric centers and the diagonals were each superposed on one another (corner-to-corner). The bond area was 248 mm2. The bond was pressed at 248 N for 5 s and stored at 23° C./50% relative humidity for 24 hours.

Immediately after the storage, the test specimen was inserted in the sample holder of the instrumented drop system in such a way that the composite was horizontal with the steel window aligned downward. The measurement was effected by instrument and automatically using a load weight of 5 kg and a drop height of 10 cm. The kinetic energy introduced by the load weight destroyed the bond by fracture of the adhesive tape between window and frame, with recording of the force by a piezoelectric sensor every us. After the measurement, the integrated software accordingly gave the graph of force against time, from which it was possible to determine the maximum force Fₘₐₓ. Shortly before the impact of the rectangular impact geometry on the window, the speed of the drop weight was determined with two light barriers. Assuming that the energy introduced is large relative to the impact resistance of the bond, the force plot, the time required before detachment and the speed of the drop weight were used to calculate the work performed on the bond until complete detachment, i.e. the detachment work. Five specimens of each sample were examined; the final result consists of the average of the detachment work or of the maximum force for these five samples.

### Preparation of the Polyacrylate

A conventional 300 I reactor for free-radical polymerizations was charged with 47 kg of n-butyl acrylate, 20 kg of methyl acrylate, 30 kg of 2-phenoxyethyl acrylate, 3 kg of acrylic acid and 72.4 kg of petroleum/acetone (70:30). After nitrogen gas had been passed through for 45 minutes while stirring, the reactor was heated up to 58° C., and 50 g of Vazo® 67 (2,2′-azo-bis(2-methylbutyronitrile)) was added. Subsequently, the jacket temperature was increased to 75° C. and the reaction was conducted in a constant manner at this outside temperature. After a reaction time of 1 h, 10 g of Vazo® 67 were added. After 3 h, the mixture was diluted with 20 kg of petroleum/acetone (70:30) and, after 6 h, with 10 kg of petroleum/acetone (70:30). For reduction of the residual initiators, 0.15 kg of Perkadox® 16 (di(4-tert-butylcyclohexyl)peroxydicarbonate) in each case was added after 5.5 h and after 7 h. The reaction was stopped after a reaction time of 24 h and cooled down to room temperature. The solution was adjusted to a solids content of 38% by weight.

### Production of the Pressure Sensitive Adhesives

### Example 1:

In a planetary roll extruder, by means of a solids metering system, the synthetic rubbers (names below, for weight ratios see table 1) were molten in granular form. Subsequently, the polyacrylate that had been concentrated and pre-melted in a single-screw extruder, the polyterpene resin Dercolyte® A115, the microballoons (Expancel® 920DU40; Nouryon) and a color paste (Levanyl® N-FL) were metered in. A crosslinker (Uvacure® 1500) was additionally added to the mixture. The melt was mixed and shaped by means of a two-roll calender between two release films (siliconized PET film) to give a layer having a thickness of 200 μm.

The composition of the resulting adhesive composition layers was as follows: 57% by weight of polyacrylate, 24% by weight of synthetic rubber (composition according to table 1), 18% by weight of Dercolyte® A115, 0.3% by weight of crosslinker, 0.7% by weight of microballoons.

Synthetic rubbers used:
SK1: Quintac® 3520 (linear SIS, Zeon; 78% diblock content; styrene content 15%)
SK2: Kraton® 1118 (linear SBS, Kraton; 78% diblock content; styrene content 33%)
SK4: Quintac® 3280 (linear SIS, Zeon; 17% diblock content; styrene content 25%)
SK5: Quintac® Q SL 196 (linear SIS, Zeon; 58% diblock content, styrene content 18%)

TABLE 1
Compositions and results

| | | | | Stretching in | | |
|---|---|---|---|---|---|---|
| | | Immediate bond | Stretching in | z direction | Du Pont test | Drop tower test |
| | Synthetic rubbers | strength 180° | z direction | Hold time (h), | (J) (fracture | (J/N) (fracture |
| No. | Weight ratio | (N/cm) | Deflection (mm) | fail rate | type) | type) |
| 1 | SK2:SK1 | 7.5 | 0.01 | >168 h, 0/3 | 0.53 (A) | 1.58/1590 |
| | 2:1 | | | | | (f.s.) |
| 2 | SK2:SK1 | 8.0 | 0.02 | >168 h, 0/3 | 0.56 (A) | 1.47/1283 |
| | 1.5:1 | | | | | (f.s.) |
| 3 | SK2:SK1 | 5.7 | 0.01 | >168 h, 0/3 | 0.35 (A) | 0.83/1270 (A) |
| | 1.3:1 | | | | | |
| 4 | SK2:SK1 | 7.64 | 0.01 | >168 h, 0/3 | not | not |
| | 2:1 | | | | determined | determined |
| 5 (ni) | SK1 | 4.0 | 0.03 | <72 h, 3/3 | 0.29 (A) | 0.46/1332 (A) |
| 6 (ni) | SK2 | 5.3 | 0.01 | >168 h, 0/3 | 0.15 (A) | 0.32/1209 (A) |
| 7 (ni) | SK2:SK1 | 8.3 | 0.03 | >168 h, 0/3 | 0.36 (A) | 1.32/1632 (A) |
| | 1:1 | | | | | |
| 8 (ni) | SK2:SK1 | 7.1 | 0.01 | ≤168 h, 1/3 | 0.31 (A) | 0.59/1067 (A) |
| | 3:1 | | | | | |
| 9 (ni) | SK1 | 5.34 | not | <144 h, 3/3 | not | not |
| | | | measurable | | determined | determined |
| 10 (ni) | SK5 | 5.17 | 0.01 | >168 h, 2/3 | not | not |
| | | | | | determined | determined |
| 11 (ni) | SK4 | 5.14 | 0.0 | >168 h, 0/3 | not | not |
| | | | | | determined | determined |

ni—not according to the invention;
A—adhesion fracture;
f.s.—foam split

1. A pressure sensitive adhesive comprising:
a) at least 50% by weight, based on a total weight of the pressure sensitive adhesive, of at least one poly(meth)acrylate;
b) 15-35% by weight, based on the total weight of the pressure sensitive adhesive, of a synthetic rubber component comprising at least one vinylaromatic-butadiene block copolymer and at least one vinylaromatic-isoprene block copolymer; and
c) at least one tackifying resin compatible with the synthetic rubber component;
wherein a weight ratio of vinylaromatic-butadiene block copolymer(s): vinylaromatic-isoprene block copolymer(s) is 1.1:1 to 2.5:1.

2. The pressure sensitive adhesive of claim 1, wherein the pressure sensitive adhesive comprises poly(meth)acrylate(s) to an extent of not more than 70% by weight, based on the total weight of the pressure sensitive adhesive.

3. The pressure sensitive adhesive of claim 1, wherein the weight ratio of vinylaromatic-butadiene block copolymer(s): vinylaromatic-isoprene block copolymer(s) is 1.3:1 to 2.3:1.

4. The pressure sensitive adhesive of claim 1, wherein the vinylaromatic-butadiene block copolymer and the vinylaromatic-isoprene block copolymer are linear block copolymers.

5. The pressure sensitive adhesive of claim 1, wherein the vinylaromatic-butadiene block copolymer has a vinylaromatic content of at least 25% by weight, based on a total weight of the vinylaromatic-butadiene block copolymer.

6. The pressure sensitive adhesive of claim 1, wherein the vinylaromatic-isoprene block copolymer has a vinylaromatic content of at most 20% by weight, based on a total weight of the vinylaromatic-isoprene block copolymer.

7. The pressure sensitive adhesive of claim 1, wherein the vinylaromatic-butadiene block copolymer is a styrene-butadiene block copolymer and the vinylaromatic-isoprene block copolymer is a styrene-isoprene block copolymer.

8. The pressure sensitive adhesive of claim 1, wherein the tackifying resin is a polyterpene resin.

9. The pressure sensitive adhesive of claim 1, wherein the pressure sensitive adhesive has been foamed.

10. An adhesive tape comprising at least one layer of the pressure sensitive adhesive of claim 1.

11. (canceled)

12. A method comprising:
bonding one or more components of a portable device with the pressure sensitive adhesive of claim 1.

13. The method of claim 12, wherein the portable device comprises a portable electronic device, a portable optical device, or a portable precision-mechanical device.

14. The method of claim 13, wherein the portable device is a smartphone or cellphone, a tablet, a notebook, a camera, a video camera, a keyboard or a touchpad.
